(19) United States
(12) Patent Application Publication
(10) Pub. No.: US 2024/0391023 A1
(43) Pub. Date: Nov. 28, 2024

(54) THERMAL PROCESSING DEVICE AND THERMAL PROCESSING METHOD

(71) Applicant: KOMATSU INDUSTRIES CORPORATION, Kanazawa-shi, Ishikawa (JP)

(72) Inventors: Yoshihiro YAMAGUCHI, Kanazawa-shi, Ishikawa (JP); Shigeru NOZAKI, Kanazawa-shi, Ishikawa (JP); Nobuhiro TAKATA, Kanazawa-shi, Ishikawa (JP)

(73) Assignee: KOMATSU INDUSTRIES CORPORATION, Kanazawa-shi, Ishikawa (JP)

(21) Appl. No.: 18/685,364

(22) PCT Filed: Aug. 3, 2022
(86) PCT No.: PCT/JP2022/029834

§ 371 Date: Feb. 21, 2024

(30) Foreign Application Priority Data
Sep. 10, 2021 (JP) 2021-147864

(51) Int. Cl. B23K 26/142; B23K 26/38

(52) U.S. Cl. CPC B23K 26/142; B23K 26/38

(57) ABSTRACT

A container supports a workpiece and is capable of storing a transmission inhibition liquid. An air blow nozzle blows gas to the workpiece supported by the container. A drive mechanism moves the air blow nozzle. A controller controls the drive mechanism so as to limit a movement trajectory of the air blow nozzle during the gas blowing to the workpiece by the air blow nozzle within a planar shape of the workpiece.

### TECHNICAL FIELD

The present disclosure relates to a thermal processing device and a thermal processing method.

### BACKGROUND ART

Conventionally, thermal processing devices such as a laser processing device using a laser beam and a plasma processing device using plasma are known. For example, Japanese Patent Laying-Open No. 8-132270 (PTL 1) and Japanese Patent Laying-Open No. 62-168692 (PTL 2) disclose a device using water in the laser processing device.

In PTL 1, the laser processing is performed while a lower portion of the workpiece is immersed in cooling water in a water tank of a processing table. Thus, the entire workpiece can be cooled from below, and stable processing can be performed.

In PTL 2, the workpiece supported by a frog pin is subjected to the laser processing while water is poured in a mounting box of the frog pin. The water in the water tank cools the workpiece during laser cutting to prevent scattering of dust.

### CITATION LIST

### Patent Literature

PTL 1: Japanese Patent Laying-Open No. 8-132270
PTL 2: Japanese Patent Laying-Open No. 62-168692

### SUMMARY OF INVENTION

### Technical Problem

In the case where the liquid such as water is used during processing in the thermal processing device, sometimes the workpiece gets wet with the liquid. In the case where the workpiece is shipped as it is as a product, beauty is poor when the workpiece remains wet with the liquid. Furthermore, when the liquid is dried, dirt contained in the liquid remains in a stain state on the workpiece, and the dirt is conspicuous. In addition, even when a corrosion inhibitor is added to the liquid, rust is likely to be generated on the workpiece due to wetting by the liquid. For this reason, when the workpiece is wet with the liquid, the liquid adhering to the surface of the workpiece is required to be wiped off with a mop or a cloth in sorting after the processing of the workpiece.

An object of the present disclosure is to provide a thermal processing device and a thermal processing method that can simplify work even when the liquid is used during the processing.

### Solution to Problem

A thermal processing device of the present disclosure is a thermal processing device that processes a workpiece using a laser beam or plasma and includes a container, an air blow nozzle, a drive mechanism, and a controller. The container supports the workpiece and is capable of storing a liquid. The air blow nozzle blows gas to the workpiece supported by the container. The drive mechanism moves the air blow nozzle. The controller controls the drive mechanism so as to limit a movement trajectory of the air blow nozzle during the gas blowing to the workpiece by the air blow nozzle within a planar shape of the workpiece.

The thermal processing method of the present disclosure includes the following steps.

A workpiece supported by a container storing a liquid is processed using a laser beam or plasma. After the workpiece is processed, an air blow nozzle blows gas to the workpiece. A movement trajectory of the air blow nozzle during the gas blowing to the workpiece by the air blow nozzle is limited within a planar shape of the workpiece.

### Advantageous Effects of Invention

According to the present disclosure, the thermal processing device and the thermal processing method that can simplify the work even when the liquid is used during the processing can be implemented.

### BRIEF DESCRIPTION OF DRAWINGS

FIG. 1 is a perspective view illustrating a configuration of a laser processing device according to an embodiment.

FIG. 2 is a sectional perspective view illustrating an internal configuration of a container used in the laser processing device of FIG. 1.

FIG. 3 is a sectional view illustrating a configuration of a processing head used in the laser processing device of FIG. 1.

FIG. 4 is a sectional view illustrating a configuration of a laser beam shielding member used in the laser processing device of FIG. 1.

FIG. 5 is a sectional view illustrating a configuration of a liquid level adjustment mechanism used in the laser processing device of FIG. 1.

FIG. 6 is a functional block diagram illustrating a controller in FIG. 5.

FIG. 7 is a plan view illustrating generation (A) of a movement trajectory of an air blow nozzle and alignment (B) with respect to a workpiece.

FIG. 8 is a flowchart illustrating a laser processing method of the embodiment.

### DESCRIPTION OF EMBODIMENT

With reference to the drawings, an embodiment of the present disclosure will be described in detail below. In the specification and the drawings, the same components or corresponding components are denoted by the same reference numerals, and redundant description will not be repeated. In the drawings, the construction may be omitted or simplified for convenience of description.

A planar view in the following description means a viewpoint viewed from a direction orthogonal to a plane on which a plurality of placement units 2c are located. A planar shape means a shape in the planar view.

### <Construction of Laser Processing Device>

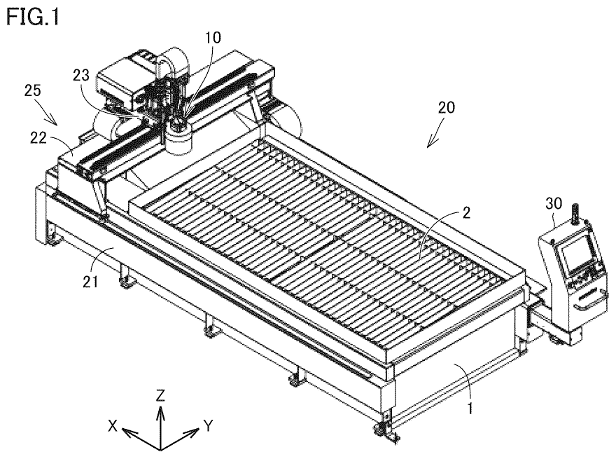

With reference to FIGS. 1 to 5, a construction of a laser processing device according to an embodiment will be described below.

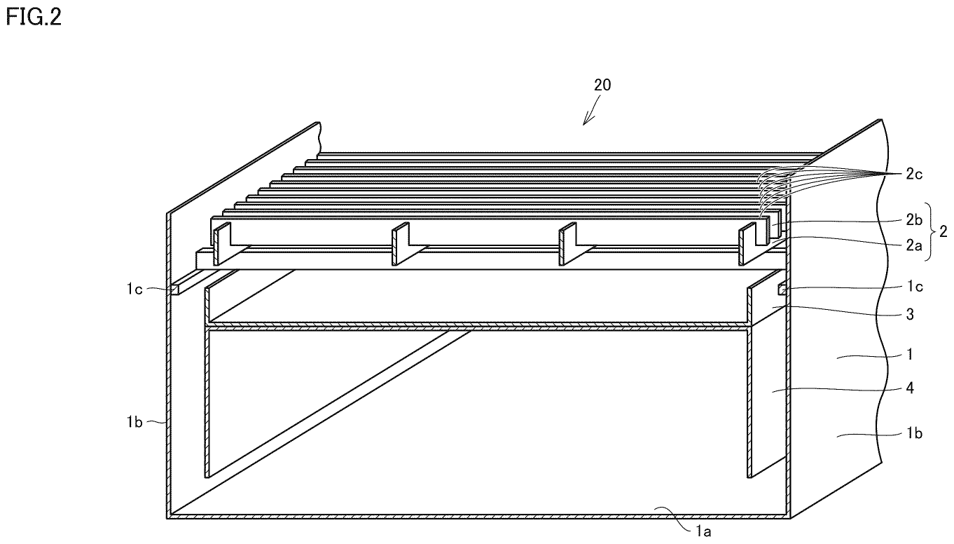

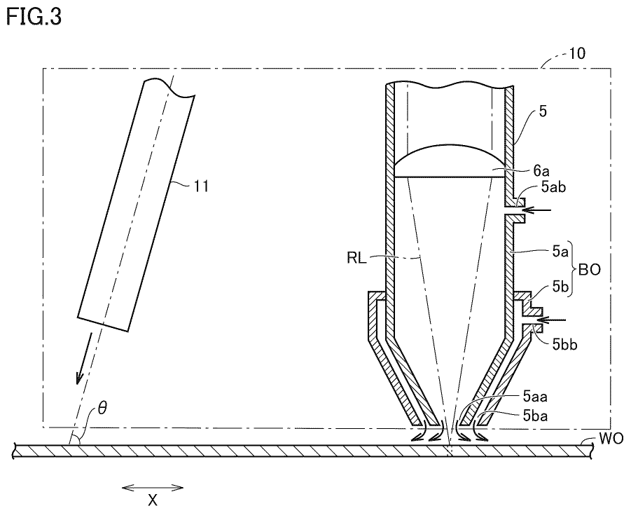

FIG. 1 is a perspective view illustrating the construction of the laser processing device of the embodiment. FIG. 2 is a sectional perspective view illustrating an internal configuration of a container used in the laser processing device of FIG. 1. FIGS. 3, 4, and 5 are sectional views illustrating configurations of a processing head, a laser beam shielding member, and a liquid level adjustment mechanism that are used in the laser processing device of FIG. 1.

As illustrated in FIGS. 1 and 2, a laser processing device 20 of the embodiment processes a workpiece made of, for example, a steel material using the laser beam. Laser processing device 20 mainly includes a container 1, a cutting pallet 2 (support member), a sludge tray 3, a liquid level adjustment tank 4, a processing head 10, a drive mechanism 25, and an operation panel 30.

As illustrated in FIG. 2, container 1 includes a rectangular bottom wall 1a and four side walls 1b rising from each of four sides of bottom wall 1a. Container 1 has a bottomed cylindrical shape with an open top. Container 1 includes an opening at an upper end and an internal space extending from the opening to an inside of container 1.

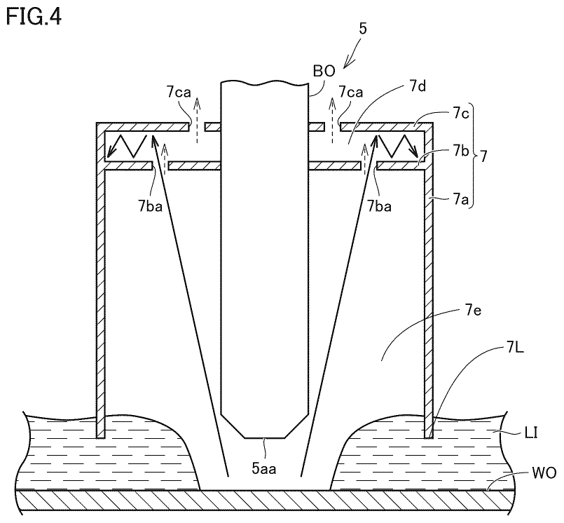

Container 1 is configured to be able to store a liquid (transmission inhibition liquid LI: FIG. 4) therein. A pallet support 1c is provided in side wall 1b. Pallet support 1c protrudes laterally from a wall surface of side wall 1b toward the internal space of container 1.

Liquid level adjustment tank 4 is disposed in the internal space of container 1. Liquid level adjustment tank 4 has a box shape including an opening at a lower end. Through this opening, the internal space of liquid level adjustment tank 4 is connected to the internal space of container 1.

Liquid level adjustment tank 4 is constructed to be able to store gas in the internal space of liquid level adjustment tank 4. The gas can be supplied to or discharged from the internal space of liquid level adjustment tank 4. Transmission inhibition liquid LI in liquid level adjustment tank 4 can be pushed out of liquid level adjustment tank 4 by supplying the gas into the internal space of liquid level adjustment tank 4. Transmission inhibition liquid LI can be taken in from the outside to the inside of liquid level adjustment tank 4 by discharging the gas from the internal space of liquid level adjustment tank 4. Thus, the liquid level in container 1 can be adjusted.

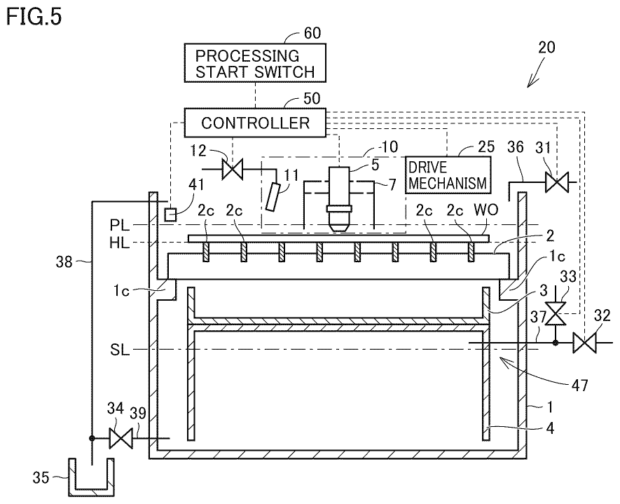

Sludge tray 3 is disposed above liquid level adjustment tank 4. Sludge tray 3 has a box shape including the opening at the upper end. Sludge tray 3 can accumulate sludge generated when a workpiece WO (FIG. 5) is cut by laser processing. The sludge generated during the laser processing falls from workpiece WO and is accumulated inside sludge tray 3 through an opening at an upper end of sludge tray 3.

Cutting pallet 2 is supported by container 1 using pallet support 1c. Cutting pallet 2 is disposed in the interior space of container 1 and above sludge tray 3. Cutting pallet 2 includes a plurality of first support plates 2a and a plurality of second support plates 2b. The plurality of first support plates 2a and the plurality of second support plates 2b are assembled in a lattice shape by being arranged vertically and horizontally.

Cutting pallet 2 includes a placement unit 2c that supports a lower surface of workpiece WO (FIG. 5). For example, placement unit 2c of cutting pallet 2 is constructed by an upper end of each of the plurality of second support plates 2b. Placement unit 2c is located at a position lower than the upper end of container 1 (the upper end of side wall 1b). The upper end of container 1 is located at a position higher than the upper surface of workpiece WO while workpiece WO is placed on placement unit 2c. Thus, when container 1 is filled with transmission inhibition liquid LI while workpiece WO is placed on placement unit 2c, a liquid level of transmission inhibition liquid LI can be made higher than the upper surface of workpiece WO.

As illustrated in FIG. 1, drive mechanism 25 moves processing head 10 in an X-direction (longitudinal direction of container 1), a Y-direction (lateral direction of container 1), and a Z-direction (vertical direction). Drive mechanism 25 mainly includes a pair of left and right support bases 21, an X-direction movable base 22, a Y-direction movable base 23, and processing head 10.

The pair of left and right support bases 21 is disposed so as to sandwich container 1 in the Y-direction. The pair of left and right support bases 21 extends in the X-direction. X-direction movable base 22 is disposed across the pair of left and right support bases 21 by extending in the Y-direction. X-direction movable base 22 is driven in the X-direction along the support base 21 by an X-axis motor (not illustrated).

Y-direction movable base 23 is supported to be movable in the Y-direction with respect to X-direction movable base 22 by, for example, a rack and pinion mechanism. Y-direction movable base 23 is driven in the Y-direction by a Y-axis motor (not illustrated).

Processing head 10 is supported to be movable in the Z-direction with respect to Y-direction movable base 23 by, for example, a rack and pinion mechanism. Processing head 10 is driven in the Z-direction by a Z-axis motor (not illustrated).

Operation panel 30 receives input of a processing condition such as a plate thickness, a material, and a processing speed of workpiece WO. Operation panel 30 includes a display, a switch, and an alarm. The display displays an input screen of the machining condition, a screen indicating an operating status of laser processing device 20, and the like.

As illustrated in FIG. 3, processing head 10 includes a laser head 5 and an air blow nozzle 11. When drive mechanism 25 (FIG. 1) moves processing head 10, laser head 5 and air blow nozzle 11 move integrally. Thus, each of laser head 5 and air blow nozzle 11 can move in each of the X-direction, the Y-direction, and the Z-direction with respect to workpiece WO supported by cutting pallet 2 of container 1.

However, air blow nozzle 11 may be provided separately from processing head 10. In this case, air blow nozzle 11 moves in each of the X-direction, the Y-direction, and the Z-direction independently of laser head 5.

Laser head 5 mainly includes a head body BO and a condensing lens 6a. Head body BO includes a body 5a.

Body 5a has a hollow cylindrical shape. Condensing lens 6a is accommodated in body 5a. Condensing lens 6a condenses a laser beam RL on workpiece WO. Laser beam RL condensed by condensing lens 6a is emitted from a laser emission port 5aa of body 5a toward workpiece WO.

Laser beam RL used in laser processing device 20 of the embodiment has any wavelength of visible light, near-infrared light, mid-infrared light, and far-infrared light, and has a wavelength greater than or equal to 0.7 μm and less than or equal to 10 μm. For example, laser beam RL is a laser beam using fiber laser as a light source, and may be a laser beam using solid-state laser containing Yttrium Aluminum Garnet (YAG) as a light source. The fiber laser is a type of solid-state laser using an optical fiber as an amplification medium. In the fiber laser, a core located at the center of the optical fiber is doped with rare earth element Yb (ytterbium). Laser beam RL using the fiber laser as a light source is near-infrared light having a wavelength of about 1.06 μm. Running cost and maintenance cost of the fiber laser are lower than those of a carbon dioxide laser.

Body 5a includes a gas outlet 5aa and a gas supply unit 5ab. An assist gas is supplied from gas supply unit 5ab into body 5a. The assist gas supplied into body 5a is blown out from gas outlet 5aa toward workpiece WO. Gas outlet 5aa also serves as a laser emission port 5aa.

Head body BO may further include an outer nozzle 5b. Outer nozzle 5b is attached to body 5a so as to surround the periphery of gas outlet 5aa of body 5a. A gap space is provided between the inner peripheral surface of outer nozzle 5b and the outer peripheral surface of body 5a.

Outer nozzle 5b includes a gas outlet 5ba and a gas supply unit 5bb. Each of gas outlet 5ba and gas supply unit 5bb is connected to the gap space. Gas outlet 5ba is disposed on an outer periphery of gas outlet 5aa, and has an annular shape.

The secondary gas (shielding gas) is supplied from gas supply unit 5bb to the gap space between body 5a and outer nozzle 5b. The secondary gas supplied into the gap space is blown out from gas outlet 5ba toward workpiece WO. Thus, the secondary gas is blown out from gas outlet 5ba onto the outer peripheral side of the assist gas blown out from gas outlet 5aa.

As described above, laser head 5 includes gas outlets 5aa, 5ba. Gas outlets 5aa, 5ba may include gas outlet 5aa through which the assist gas is blown out and gas outlet 5ba through which the secondary gas is blown out. Gas outlet 5aa and gas outlet 5ba form a double nozzle structure.

Air blow nozzle 11 blows gas onto the upper surface of workpiece WO supported by cutting pallet 2 of container 1. When air blow nozzle 11 blows gas onto the upper surface of workpiece WO, transmission inhibition liquid LI (liquid) on the upper surface of workpiece WO is blown off from the upper surface of workpiece WO. Thus, transmission inhibition liquid LI adhering to the upper surface of workpiece WO can be removed.

Air blow nozzle 11 is inclined at an angle θ with respect to the upper surface of workpiece WO. Thus, air blow nozzle 11 obliquely blows out the gas with respect to the upper surface of workpiece WO. For example, the gas blown out from air blow nozzle 11 is compressed air, but may be compressed inert gas or the like.

As illustrated in FIG. 4, laser head 5 includes a light shielding cover 7. Light shielding cover 7 surrounds laser emission port 5aa (gas outlet 5aa). For example, light shielding cover 7 is made of a rubber sheet. Light shielding cover 7 includes a peripheral wall 7a, a first upper plate 7b, and a second upper plate 7c. Peripheral wall 7a has a cylindrical shape surrounding the outer periphery of head body BO.

First upper plate 7b and second upper plate 7c are attached to an upper portion of peripheral wall 7a. One or a plurality of first holes 7ba are made in first upper plate 7b. Second upper plate 7c is disposed on first upper plate 7b with a gap 7d interposed therebetween.

One or a plurality of second holes 7ca are made in second upper plate 7c. An internal space 7e of peripheral wall 7a located below first upper plate 7b is connected to the external space of light shielding cover 7 through first hole 7ba and second hole 7ca. For this reason, even when the liquid level of transmission inhibition liquid LI is located to a position higher than a lower end 7L of peripheral wall 7a of light shielding cover 7 during the laser processing, the gas in internal space 7e of light shielding cover 7 escapes to the outside of light shielding cover 7 through first hole 7ba and second hole 7ca by such the structure.

First hole 7ba, gap 7d, and second hole 7ca form a labyrinth structure with respect to the laser beam. Specifically, as indicated by a solid arrow in FIG. 4, second hole 7ca is not positioned ahead of the laser beam that is emitted from laser emission port 5aa of laser head 5 and reflected from workpiece WO, passes through first hole 7ba, and then travels linearly in gap 7d. For example, second hole 7ca is located on an inner peripheral side of first hole 7ba at a position in a radial direction centered on laser head 5.

The laser beam that passes through first hole 7ba and enters gap 7d is repeatedly reflected between first upper plate 7b and second upper plate 7c (by multiple reflection) and absorbed by light shielding cover 7. Thus, the laser beam does not leak from the inside of light shielding cover 7 to the outside.

As illustrated in FIG. 5, a supply pipe 36 is provided in order to supply transmission inhibition liquid LI (FIG. 4) into container 1. A supply valve 31 is attached to supply pipe 36. The supply of transmission inhibition liquid LI to the internal space of container 1 is started by opening supply valve 31, and the supply of transmission inhibition liquid LI to the internal space of container 1 is stopped by closing supply valve 31.

A gas pipe 37 is connected to the liquid level adjustment tank 4 from the outside of container 1. A pressurizing valve 32 and a pressure reducing valve 33 are attached to gas pipe 37. The gas is supplied into liquid level adjustment tank 4 when pressurizing valve 32 is opened, and the supply of the gas into liquid level adjustment tank 4 is stopped when the pressurizing valve 32 is closed. The gas in liquid level adjustment tank 4 is discharged to the outside by opening pressure reducing valve 33, and the discharge of the gas from liquid level adjustment tank 4 is stopped by closing pressure reducing valve 33. Liquid level adjustment tank 4, gas pipe 37, pressurizing valve 32, and pressure reducing valve 33 are included in a liquid level adjustment mechanism 47. As described later, liquid level adjustment mechanism 47 adjusts the liquid level of transmission inhibition liquid LI in container 1 based on a detection result of a liquid level detection sensor 41.

An overflow pipe 38 is attached to container 1. When the liquid level of transmission inhibition liquid LI in container 1 becomes greater than or equal to a predetermined liquid level, transmission inhibition liquid LI in container 1 is discharged to a liquid storage tank 35 through overflow pipe 38. Liquid storage tank 35 is disposed outside container 1.

A liquid discharge pipe 39 is attached to container 1. A discharge valve 34 is attached to liquid discharge pipe 39. Transmission inhibition liquid LI in container 1 is discharged to liquid storage tank 35 by opening discharge valve 34, and the discharge of transmission inhibition liquid LI from container 1 is stopped by closing discharge valve 34.

Container 1 is configured to be capable of storing transmission inhibition liquid LI at least up to a height position HL of placement unit 2c. Container 1 is capable of storing transmission inhibition liquid LI up to a position PL higher than the upper surface of workpiece WO placed on placement unit 2c.

Transmission inhibition liquid LI stored in container 1 inhibits transmission of the laser beam. For example, transmission inhibition liquid LI inhibits the transmission of the light having a wavelength greater than or equal to 0.7 μm and less than or equal to 10 μm.

For example, the transmittance of the light in a wavelength range greater than or equal to 0.7 μm and less than or equal to 10 μm in transmission inhibition liquid LI is less than or equal to 10%/cm. For example, the transmittance of the light in the wavelength range greater than or equal to 0.7 μm and less than or equal to 10 μm in transmission inhibition liquid LI is preferably less than or equal to 5%/cm. For example, the transmittance of the light in the wavelength range greater than or equal to 0.7 μm and less than or equal to 10 μm in transmission inhibition liquid LI is more preferably less than or equal to 3%/cm.

Transmission inhibition liquid LI contains an additive that absorbs or scatters the light in the wavelength range greater than or equal to 0.7 μm and less than or equal to 10 μm in order to inhibit the transmission of the light in the wavelength range greater than or equal to 0.7 μm and less than or equal to 10 μm. For example, this additive contains carbon. The additive is preferably black. For example, transmission inhibition liquid LI is an aqueous solution obtained by adding carbon to water. For example, transmission inhibition liquid LI is an aqueous solution obtained by adding 0.1 vol % of India ink to water. The water in the present specification may be tap water or pure water. The India ink is obtained by dispersing carbon black (carbon) in an aqueous solution of glue or another water-soluble resin, and a mixing ratio of the carbon black is 4.0 wt % to 20.0 wt %, preferably 5.0 wt % to 10.0 wt % with respect to the total amount. For example, the India ink is commercially available “Kuretake concentrated ink Bokuteki BA7-18”.

Transmission inhibition liquid LI preferably contains a rust inhibitor. The rust inhibitor is a corrosion inhibitor that inhibits corrosion of a steel material or the like. For example, the rust inhibitor is water-soluble. For example, a precipitated film type inhibitor, a passive type inhibitor, or a deoxygenated type inhibitor may be used as the rust inhibitor.

Preferably transmission inhibition liquid LI contains a water substituting agent (water draining agent). The water substituting agent improves a water draining property of workpiece WO. The water substituting agent is a solvent that peels liquid such as water from a surface of a substance wetted with the liquid. For example, the water substituting agent may act to repel the liquid such as water by forming a monomolecular thin film on the surface of the substance.

Laser processing device 20 further includes a liquid level detection sensor 41, a controller 50, and a processing start switch 60.

Liquid level detection sensor 41 is installed in container 1 and has a function of detecting the liquid level of transmission inhibition liquid LI stored in container 1. For example, liquid level detection sensor 41 is a guide pulse type level sensor.

Processing start switch 60 issues an instruction to start the laser processing by laser processing device 20, for example, in response to an external operation by an operator or the like. Processing start switch 60 may be provided on operation panel 30. Processing start switch 60 may be a touch panel provided on operation panel 30.

Controller 50 controls to open and close supply valve 31, pressurizing valve 32, pressure reducing valve 33, and discharge valve 34. Although a line connecting controller 50 and discharge valve 34 is not illustrated in FIG. 5, this is for simplification of the drawing. Controller 50 controls drive mechanism 25 such that processing head 10 moves in the X-, Y-, and Z-directions. Controller 50 controls laser emission from laser head 5.

Controller 50 receives a signal indicating the liquid level of transmission inhibition liquid LI in container 1 detected by liquid level detection sensor 41. Controller 50 receives a signal indicating a processing start instruction by processing start switch 60.

Controller 50 controls opening and closing of pressurizing valve 32 or pressure reducing valve 33 based on the detection result of liquid level detection sensor 41. Thus, an amount of gas stored in liquid level adjustment tank 4 is adjusted, and the liquid level of transmission inhibition liquid LI stored in container 1 is adjusted. In this manner, controller 50 controls the opening and closing of pressurizing valve 32 or pressure reducing valve 33 such that liquid level adjustment mechanism 47 (liquid level adjustment tank 4, gas pipe 37, pressurizing valve 32, and pressure reducing valve 33) adjusts the liquid level of transmission inhibition liquid LI stored in container 1.

Controller 50 controls liquid level adjustment mechanism 47 and laser oscillation by laser head 5. Thus, controller 50 causes liquid level adjustment mechanism 47 to make the liquid level of transmission inhibition liquid LI stored in container 1 higher than the upper surface of workpiece WO (after workpiece WO is immersed in transmission inhibition liquid LI), and then emits the laser beam from laser head 5 to workpiece WO.

Controller 50 controls laser head 5 and drive mechanism 25. Thus, controller 50 moves laser head 5 along a preset movement trajectory during laser processing (when the laser beam is emitted from laser head 5).

Controller 50 controls to open and close valve 12. Blowing of the gas from air blow nozzle 11 is controlled by the opening and closing of valve 12. Specifically, valve 12 is opened to blow out the gas from air blow nozzle 11, and valve 12 is closed to stop the blowing out of the gas from air blow nozzle 11. The gas is blown out by air blow nozzle 11 in order to blow off transmission inhibition liquid LI adhering to the upper surface of workpiece WO after the laser processing is completed.

Controller 50 controls liquid level adjustment mechanism 47 and valve 12. Thus, controller 50 causes liquid level adjustment mechanism 47 to lower the liquid level of transmission inhibition liquid LI stored in container 1 than the upper surface of workpiece WO, and then blows the gas to workpiece WO through air blow nozzle 11.

Controller 50 controls valve 12 and drive mechanism 25. Thus, controller 50 limits the movement trajectory of air blow nozzle 11 during the gas blowing to workpiece WO by air blow nozzle 11 within the planar shape of workpiece WO.

For example, controller 50 is a processor, and may be a central processing unit (CPU).

### <Functional Block of Controller>

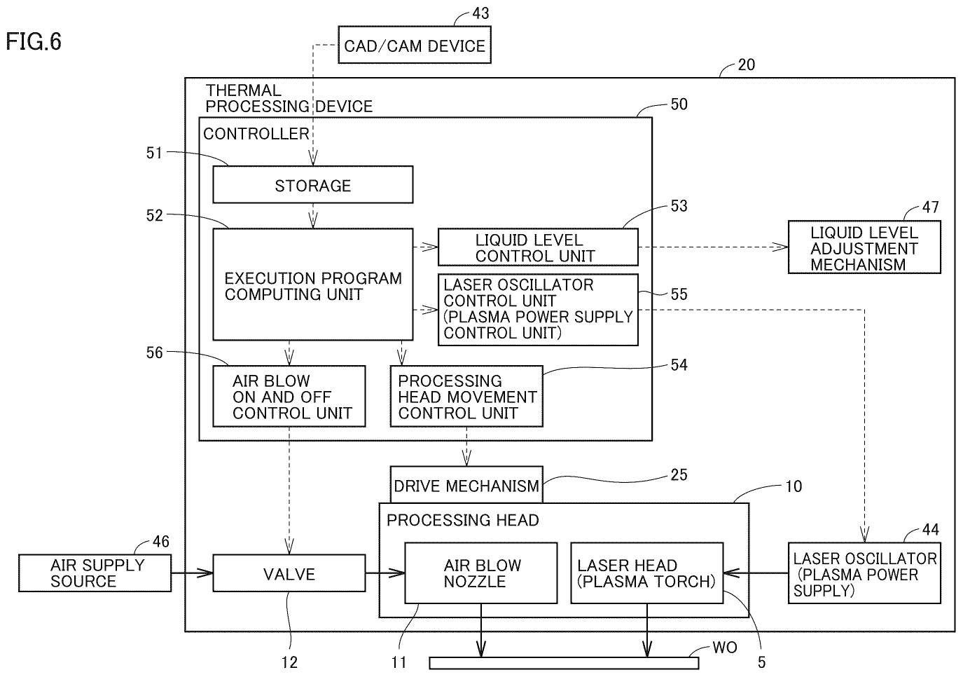

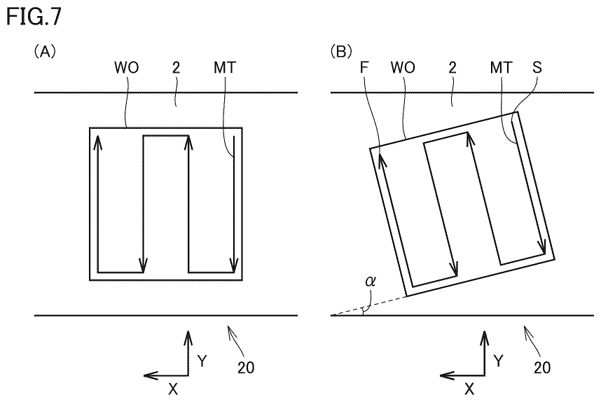

With reference to FIGS. 6 and 7, a functional block of controller 50 in FIG. 5 will be described below.

FIG. 6 is a functional block diagram illustrating the controller in FIG. 5. FIG. 7 is a planar view illustrating generation (A) of the movement trajectory of the air blow nozzle and alignment (B) with respect to the workpiece.

As illustrated in FIG. 6, controller 50 includes a storage 51, an execution program computing unit 52, a liquid level control unit 53, a processing head movement control unit 54, a laser oscillator control unit 55, and an air blow on and off control unit 56.

An execution program generated by a CAD (Computer Aided Design)/CAM (Computer Aided Manufacturing) device 43 is input to storage 51, so that storage 51 stores and saves an execution program. For example, CAD/CAM device 43 is a personal computer.

The execution program includes processing data and air blow data. The processing data includes data of the movement trajectory (for example, a product shape) of laser head 5 or plasma torch 5 and data of processing conditions (processing speed, laser output/plasma output, and the like). The air blow data includes movement trajectory data of air blow nozzle 11 and outer shape data of workpiece WO.

Execution program computing unit 52 outputs a control signal to each of liquid level control unit 53, processing head movement control unit 54, laser oscillator control unit 55, and air blow on and off control unit 56 based on the execution program stored in storage 51. When the air blow data included in the execution program does not include movement trajectory data of air blow nozzle 11, execution program computing unit 52 generates the movement trajectory data of air blow nozzle 11.

The movement trajectory data of air blow nozzle 11 is generated based on the outer shape data of workpiece WO, an inclination angle θ (FIG. 3) of air blow nozzle 11, and the like. Specifically, as illustrated in FIG. 7(A), a movement trajectory MT of air blow nozzle 11 in blowing the gas onto workpiece WO is generated so as to be limited within the planar shape of workpiece WO in the planar view. At this point, in consideration of the inclination angle θ of air blow nozzle 11 as described above, movement trajectory MT of air blow nozzle 11 is generated such that the gas blown out from air blow nozzle 11 does not directly hit transmission inhibition liquid LI stored in container 1.

Movement trajectory MT of air blow nozzle 11 described above means the movement trajectory at a point where the gas blown out from air blow nozzle 11 hits the upper surface of workpiece WO. “Movement trajectory MT of air blow nozzle 11 is limited within the planar shape of workpiece WO” means that movement trajectory MT of air blow nozzle 11 is limited within the range of the planar shape of workpiece WO in the planar view but does not go out of the planar shape of workpiece WO.

Movement trajectory MT of air blow nozzle 11 is generated such that the gas blown out from air blow nozzle 11 directly hits workpiece WO but does not directly hit transmission inhibition liquid LI located below the upper surface of workpiece WO outside the planar shape of workpiece WO. As illustrated in FIG. 3, air blow nozzle 11 blows the gas obliquely to the upper surface of workpiece WO. Accordingly, even in such a case, movement trajectory MT of air blow nozzle 11 is generated such that the gas blown out from air blow nozzle 11 directly hits workpiece WO but does not directly hit transmission inhibition liquid LI stored in container 1.

As illustrated in FIG. 6, the liquid level control unit 53 outputs a control signal to the liquid level adjustment mechanism 47 based on the control signal from execution program computing unit 52. Specifically, liquid level control unit 53 outputs a signal controlling the opening and closing of each of pressurizing valve 32 and pressure reducing valve 33.

Processing head movement control unit 54 outputs a control signal to drive mechanism 25 based on the control signal from execution program computing unit 52. Specifically, processing head movement control unit 54 outputs the signal controlling the drive of each of the X-axis motor, the Y-axis motor, and the Z-axis motor of drive mechanism 25. Thus, the movement in the X-direction, the Y-direction, and the Z-direction of processing head 10 is controlled.

Laser oscillator control unit 55 outputs a control signal to laser oscillator 44 based on the control signal from execution program computing unit 52. Specifically, laser oscillator control unit 55 outputs the signal controlling the on and off of laser beam oscillation by laser oscillator 44. When the laser beam oscillation by laser oscillator 44 is turned on, the laser beam is oscillated from laser oscillator 44 and emitted to workpiece WO through laser head 5. Thus, workpiece WO is processed.

Air blow on and off control unit 56 outputs a signal controlling the opening and closing of valve 12 based on the control signal from execution program computing unit 52. When valve 12 is controlled to be opened, the gas is supplied from air supply source 46 to air blow nozzle 11. Thus, the gas is blown from air blow nozzle 11 to the upper surface of workpiece WO. When valve 12 is controlled to be closed, the supply of the gas from air supply source 46 to air blow nozzle 11 is stopped. Thus, the blowing of the gas from air blow nozzle 11 to the upper surface of workpiece WO is stopped.

When the gas is blown onto workpiece WO by air blow nozzle 11, controller 50 controls drive mechanism 25 so as to limit the movement trajectory of air blow nozzle 11 within the planar shape of workpiece WO. Specifically, controller 50 controls the blowing of the gas to workpiece WO by air blow nozzle 11 as follows.

Execution program computing unit 52 confirms the position information on cutting pallet 2 of workpiece WO carried in laser processing device 20. As illustrated in FIG. 7(B), for example, sometimes one side of workpiece WO having a rectangular planar shape is inclined at an angle α with respect to the X-direction of thermal processing device 20. In this case, execution program computing unit 52 confirms an inclined position of workpiece WO.

Thereafter, execution program computing unit 52 aligns the position of generated movement trajectory MT of air blow nozzle 11 with the confirmed position of workpiece WO. Specifically, execution program computing unit 52 adjusts the position and inclination of generated movement trajectory MT of air blow nozzle 11 to the position and inclination of inclined workpiece WO. Even when workpiece WO is placed on cutting pallet 2 in an inclined manner by this alignment, movement trajectory MT of air blow nozzle 11 during the gas blowing is limited within the planar shape of workpiece WO.

Execution program computing unit 52 controls drive mechanism 25 through processing head movement control unit 54 such that processing head 10 moves according to movement trajectory MT of air blow nozzle 11. When air blow nozzle 11 reaches a gas blowout start point S on movement trajectory MT, execution program computing unit 52 controls to open valve 12 through air blow on and off control unit 56. This causes air blow nozzle 11 to start the blowing of the gas to workpiece WO.

Thereafter, execution program computing unit 52 controls drive mechanism 25 such that air blow nozzle 11 moves in the planar shape of workpiece WO along movement trajectory MT in the planar view while valve 12 is kept open. When air blow nozzle 11 reaches a gas blow end point F on movement trajectory MT, execution program computing unit 52 controls valve 12 to be closed through air blow on and off control unit 56. Thus, the blowing of the gas to workpiece WO by air blow nozzle 11 is stopped.

As described above, controller 50 has a function of controlling the gas blowing to workpiece WO by air blow nozzle 11. The confirmation of the position information on cutting pallet 2 of workpiece WO carried in laser processing device 20 and the alignment of the confirmed position of workpiece WO and movement trajectory MT may be performed by CAD/CAM device 43.

### <Laser Processing Method>

With reference to FIGS. 3 to 8, a laser processing method using laser processing device 20 of the embodiment will be described below.

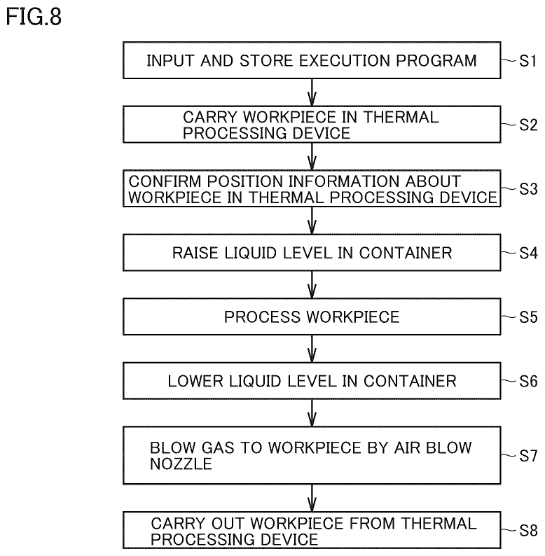

FIG. 8 is a flowchart illustrating the laser processing method of the embodiment. As illustrated in FIG. 5, transmission inhibition liquid LI is supplied into container 1 of laser processing device 20. At this point, controller 50 controls to open supply valve 31. Thus, transmission inhibition liquid LI is supplied from supply pipe 36 into container 1. At this point, controller 50 detects the liquid level of transmission inhibition liquid LI in container 1 using liquid level detection sensor 41. When determining that the liquid level of transmission inhibition liquid LI in container 1 reaches a desired liquid level SL based on the detection result of liquid level detection sensor 41, controller 50 controls supply valve 31 to be closed. At this point, for example, transmission inhibition liquid LI is supplied to a position SL lower than height position HL of placement unit 2c of cutting pallet 2.

As illustrated in FIG. 6, the execution program is generated in CAD/CAM device 43. As described above, the execution program includes the processing data and the air blow data. The execution program generated by CAD/CAM device 43 is input and saved in storage 51 in controller 50 of thermal processing device 20 (step S1 in FIG. 8).

As illustrated in FIG. 5, thereafter, workpiece WO is carried in thermal processing device 20 (step S2 in FIG. 8). By this carrying-in, workpiece WO is placed on placement unit 2c of cutting pallet 2.

The position information about workpiece WO in thermal processing device 20 is conformed while workpiece WO is placed on placement unit 2c (step S3 in FIG. 8). For example, the position of workpiece WO in thermal processing device 20 is confirmed by coordinates of three points on the outer shape of workpiece WO and the planar shape of workpiece WO.

For example, the coordinates of the three points on the outer shape of workpiece WO placed on cutting pallet 2 are obtained by scanning with a laser pointer. For example the coordinates of the three points on the outer shape of workpiece WO placed on cutting pallet 2 may be acquired from an image captured by a charge coupled device (CCD) camera.

As illustrated in FIG. 6, execution program computing unit 52 of controller 50 confirms the position information about workpiece WO in thermal processing device 20 based on the acquired coordinates of the three points in the outer shape of workpiece WO and the outer shape data of workpiece WO stored in storage 51. In this state, the laser processing operation by laser processing device 20 is started.

As illustrated in FIG. 5, for example, the laser processing operation in laser processing device 20 is started by operating processing start switch 60. When the laser processing operation is started, controller 50 raises the liquid level of transmission inhibition liquid LI stored in container 1 to a target liquid level PL based on the detection result of liquid level detection sensor 41 (step S4 in FIG. 8).

Target liquid level PL of transmission inhibition liquid LI is higher than height position HL of placement unit 2c. In the embodiment, for example, target liquid level PL of transmission inhibition liquid LI is adjusted to the position PL higher than the upper surface of workpiece WO. As a result, entire workpiece WO sinks (is immersed) in transmission inhibition liquid LI.

When the liquid level of transmission inhibition liquid LI is raised to the target liquid level PL, execution program computing unit 52 controls liquid level adjustment mechanism 47 through liquid level control unit 53 as illustrated in FIG. 6. Specifically, for example, controller 50 controls to open pressurizing valve 32 as illustrated in FIG. 5. Thus, the gas is supplied into liquid level adjustment tank 4, and the liquid level of transmission inhibition liquid LI stored in container 1 is adjusted to be high to target liquid level PL.

When liquid level detection sensor 41 detects that the liquid level of transmission inhibition liquid LI reaches the target liquid level PL, the processing of workpiece WO is started (step S5 in FIG. 8). During the processing of workpiece WO, as illustrated in FIG. 6, execution program computing unit 52 controls laser oscillator 44 through laser oscillator control unit 55. Thus, the laser beam is emitted from laser head 5.

During the processing of workpiece WO, as illustrated in FIG. 6, execution program computing unit 52 controls drive mechanism 25 through processing head movement control unit 54. Thus, laser head 5 moves along the movement trajectory (for example, the product shape) of laser head 5 stored in storage 51.

As illustrated in FIG. 3, workpiece WO is irradiated with the laser beam from laser head 5 during the laser processing. Furthermore, an assist gas is blown from laser head 5 toward workpiece WO.

As illustrated in FIG. 4, transmission inhibition liquid LI is pushed away at a processing point of workpiece WO by blowing force of the assist gas. Thus, the upper surface of workpiece WO is exposed from transmission inhibition liquid LI at the processing point of workpiece WO.

The upper surface of workpiece WO exposed from transmission inhibition liquid LI is irradiated with the laser beam. Workpiece WO is processed by the irradiation with the laser beam. Thus, for example, workpiece WO is cut. The laser beam that penetrates workpiece WO by cutting workpiece WO enters transmission inhibition liquid LI stored below workpiece WO.

During the laser processing, the liquid level of transmission inhibition liquid LI is higher than lower end 7L of light shielding cover 7. For this reason, the assist gas blown out from laser head 5 is blocked by transmission inhibition liquid LI, but does not escape from between lower end 7L of light shielding cover 7 and the upper surface of workpiece WO to the outside of light shielding cover 7. The assist gas blown out from laser head 5 passes from the inside to the outside of light shielding cover 7 through first hole 7ba of first upper plate 7b and second hole 7ca of second upper plate 7c. This prevents an increase in the pressure of the gas inside light shielding cover 7 due to the blowing of the assist gas.

The sludge generated when workpiece WO is cut by the laser processing sinks into transmission inhibition liquid LI and accumulates in sludge tray 3 (FIG. 5). For example, the sludge is iron oxide particles in which molten iron is hardened. As described above, the laser processing is performed while workpiece WO is immersed in transmission inhibition liquid LI, whereby scattering of the sludge generated during the processing to the surroundings is prevented.

When the laser processing is completed, as illustrated in FIG. 5, controller 50 lowers the liquid level of transmission inhibition liquid LI stored in container 1 to the position lower than the lower surface of workpiece WO based on the detection result of liquid level detection sensor 41 (step S6 in FIG. 8). Thus, entire workpiece WO is exposed from transmission inhibition liquid LI.

When the liquid level of transmission inhibition liquid LI is lowered to the position lower than the lower surface of workpiece WO, execution program computing unit 52 controls liquid level adjustment mechanism 47 through liquid level control unit 53 as illustrated in FIG. 6. Specifically, as illustrated in FIG. 5, for example, controller 50 controls pressure reducing valve 33 to open after the detection of the end of the laser processing. Thus, the amount of gas stored in liquid level adjustment tank 4 is reduced, and transmission inhibition liquid LI flows into liquid level adjustment tank 4. Therefore, the liquid level of transmission inhibition liquid LI in container 1 is lowered. At this point, controller 50 detects the liquid level of transmission inhibition liquid LI in container 1 using liquid level detection sensor 41. When determining that the liquid level of transmission inhibition liquid LI in container 1 reaches the desired liquid level SL, controller 50 controls pressure reducing valve 33 to be closed.

Thereafter, the gas is blown to workpiece WO by air blow nozzle 11 (step S7 in FIG. 8). Before the gas blowing, as illustrated in FIG. 7(B), the position of movement trajectory MT of air blow nozzle 11 is aligned with the confirmed position of workpiece WO on cutting pallet 2. This alignment is performed by execution program computing unit 52 illustrated in FIG. 6. After performing the alignment, execution program computing unit 52 controls drive mechanism 25 through processing head movement control unit 54. Thus, air blow nozzle 11 moves along movement trajectory MT designated by an instruction from controller 50. Movement trajectory MT is limited within the planar shape of workpiece WO.

In the gas blowing described above, compressed air is blown from air blow nozzle 11 onto the upper surface of workpiece WO. Thus, the liquid adhering to the upper surface of workpiece WO is blown off by the compressed air and removed from the upper surface of workpiece WO.

After the gas blowing is finished, workpiece WO is carried out from thermal processing device 20 (step S8 in FIG. 8). During this carrying-out, workpiece WO is sorted into a product and a remaining frame. This carrying-out may be performed by an operator attracting workpiece WO to a magnet.

As needed, cutting pallet 2 and sludge tray 3 are taken out of container 1. After that, the sludge in sludge tray 3 is removed.

As described above, the laser processing using laser processing device 20 of the embodiment is performed.

### Advantageous Effect of Embodiment

An advantageous effect of the embodiment will be described below.

In the embodiment, as illustrated in FIG. 7(B), the gas is blown to workpiece WO by air blow nozzle 11. Thus, transmission inhibition liquid LI adhering to the upper surface of workpiece WO is blown off and removed. For this reason, degradation of beauty due to transmission inhibition liquid LI remaining on the upper surface of workpiece WO is not generated. Furthermore, the generation of dirt and stain due to drying of the liquid adhering to the upper surface of workpiece WO can also be prevented. The generation of rust due to the liquid remaining on the upper surface of workpiece WO can also be prevented.

The gas blowing by air blow nozzle 11 is automatically performed under the control of controller 50. This eliminates a need for a manual wiping operation of transmission inhibition liquid LI on the surface of workpiece WO. Accordingly, manual labor can be reduced, and the operation can be simplified even when the liquid such as transmission inhibition liquid LI is used during the processing.

In addition, when the gas blown out from air blow nozzle 11 directly hits transmission inhibition liquid LI, transmission inhibition liquid LI is blown up to wet not only workpiece WO but also a vicinity of thermal processing device 20.

On the other hand, in the embodiment, as illustrated in FIG. 7(B), movement trajectory MT of air blow nozzle 11 during the gas blowing to workpiece WO is limited within the planar shape of workpiece WO. For this reason, the gas blown out from air blow nozzle 11 is prevented from being directly blown to transmission inhibition liquid LI stored in container 1. For this reason, transmission inhibition liquid LI can be prevented from wetting the surface of workpiece WO and the vicinity of laser processing device 20, transmission inhibition liquid LI being blown up by the gas that directly hits transmission inhibition liquid LI.

In the embodiment, as illustrated in FIG. 6, air blow nozzle 11 is movable in the vertical direction with respect to workpiece WO. Thus, the gas outlet of air blow nozzle 11 can be brought close to the upper surface of workpiece WO. For this reason, transmission inhibition liquid LI adhering to the upper surface of workpiece WO can be efficiently blown off with the gas.

In the embodiment, as illustrated in FIG. 3, air blow nozzle 11 is attached to processing head 10. For this reason, air blow nozzle 11 can be moved by the drive mechanism that moves processing head 10. This eliminates the need for the drive mechanism dedicated to air blow nozzle 11.

In the embodiment, as illustrated in FIG. 3, air blow nozzle 11 blows out the gas obliquely with respect to the upper surface of workpiece WO. Thus, the gas blown out from air blow nozzle 11 is prevented from going around to the lower side of workpiece WO through a gap of workpiece WO formed by the processing. For this reason, transmission inhibition liquid LI on the lower side of workpiece WO is prevented from being blown up by the gas flowing around to the lower side of workpiece WO through the gap.

In the embodiment, transmission inhibition liquid LI contains the water substituting agent that improves the water draining property of workpiece WO. Thus, the liquid adhering to the surface of workpiece WO is easily removed from workpiece WO by its own gravity. For this reason, wetting of a back surface side of workpiece WO can also be minimized.

When air blow nozzle 11 moves from near one end to near the other end of workpiece WO in the Y-direction along movement trajectory MT as illustrated in FIG. 7(A), air blow nozzle 11 is preferably inclined along, for example, the X-direction as illustrated in FIG. 3.

In the embodiment, as an example of thermal processing device 20, the laser processing device that processes workpiece WO using the laser beam has been described. However, thermal processing device 20 of the present disclosure may be a plasma processing device that processes workpiece WO using plasma instead of the laser processing device.

In the plasma processing device, dust generated when workpiece WO is subjected to plasma processing without a large-scale dust collector can efficiently be collected by storing the liquid in container 1, and an effect of improving cutting accuracy by reducing thermal strain cam also be obtained.

However, for example, when workpiece WO is cut using plasma processing device 20, a width of a cutting groove is larger than that in the case of the laser processing. For this reason, even when the liquid level of the liquid stored in container 1 is lower than the upper surface of workpiece WO, when a plasma jet hits the liquid during the plasma processing, the liquid is blown up to the upper surface side of workpiece WO through the cutting groove to wet workpiece WO. As described above, even when workpiece WO is wetted with the liquid by the plasma processing, the liquid can be removed from workpiece WO with less effort by applying the present disclosure.

When thermal processing device 20 is the plasma processing device, a plasma power supply control unit 55, a plasma power supply 44, and plasma torch 5 are used instead of each of laser oscillator control unit 55, laser oscillator 44, and laser head 5 in the above description. As illustrated in FIG. 6, plasma power supply control unit 55 outputs a signal controlling the on and off of plasma power supply 44. When plasma power supply 44 is turned on, the plasma is generated in plasma torch 5, and workpiece WO is processed by the plasma.

In the embodiment described above, workpiece WO is processed while the liquid level of transmission inhibition liquid LI is raised to the position higher than the upper surface of workpiece WO. However, the present disclosure is not limited to this content, but the liquid level of transmission inhibition liquid LI in processing workpiece WO may be a height less than or equal to the upper surface of workpiece WO.

In the embodiment, transmission inhibition liquid LI has been described as the liquid stored in container 1. However, the present disclosure is not limited to this content, and the liquid stored in container 1 may be a cooling liquid (for example, water) cooling workpiece WO or may be a scattering preventing liquid preventing scattering of sludge.

It should be considered that the disclosed embodiment is illustrative and non-restrictive in every respect. The scope of the present invention is defined by not the description above, but the claims, and it is intended that all modifications within the meaning and scope equivalent to the claims are included in the present invention.

### REFERENCE SIGNS LIST

1: container, 1a: bottom wall, 1b: side wall, 1c: pallet support, 2: cutting pallet, 2a: first support plate, 2b: second support plate, 2c: placement unit, 3: sludge tray, 4: liquid level adjustment tank, 5: laser head (plasma torch), 5a: body, 5aa: laser emission port (gas outlet), 5ba: gas outlet, 5ab, 5bb: gas supply unit, 5b: outer nozzle, 6a: condensing lens, 7: light shielding cover, 7L: lower end, 7a: peripheral wall, 7b: first upper plate, 7ba: first hole, 7c: second upper plate, 7ca: second hole, 7d: gap, 7e: internal space, 10: processing head, 11: air blow nozzle, 12: valve, 20: thermal processing device, 21: support base, 22: X-direction movable base, 23: Y-direction movable base, 25: drive mechanism, 30: operation panel, 31: supply valve, 32: pressurizing valve, 33: pressure reducing valve, 34: discharge valve, 35: liquid storage tank, 36: supply pipe, 37: gas pipe, 38: overflow pipe, 39: liquid discharge piping, 41: liquid level detection sensor, 42: transmittance detection sensor, 43: CAD/CAM device, 44: laser oscillator (plasma power supply), 46: air supply source, 47: liquid level adjustment mechanism, 50: controller, 51: storage, 52: execution program computing unit, 53: liquid level control unit, 54: processing head movement control unit, 55: laser oscillator control unit (plasma power supply control unit), 56: air blow on and off control unit, 60: processing start switch, BO: head body, LI: transmission inhibition liquid, MT: movement trajectory, WO: workpiece

1: A thermal processing device that processes a workpiece using a laser beam or plasma, the thermal processing device comprising:
a container that supports the workpiece and is capable of storing a liquid;
an air blow nozzle that blows gas to the workpiece supported by the container;
a drive mechanism that moves the air blow nozzle; and
a controller that controls the drive mechanism so as to limit a movement trajectory of the air blow nozzle during the gas blowing to the workpiece by the air blow nozzle within a planar shape of the workpiece.

2: The thermal processing device according to claim 1, wherein the air blow nozzle is movable in a vertical direction with respect to the workpiece.

3: The thermal processing device according to claim 1,
further comprising a processing head that includes a laser head or a plasma torch and is movable with respect to the workpiece,
wherein the processing head includes the air blow nozzle.

4: The thermal processing device according to claim 1, wherein the air blow nozzle blows out gas obliquely with respect to an upper surface of the workpiece.

5: A thermal processing method comprising:
processing a workpiece supported by a container storing a liquid using a laser beam or plasma; and
blowing gas to the workpiece using an air blow nozzle after the workpiece is processed,
wherein a movement trajectory of the air blow nozzle during the gas blowing to the workpiece by the air blow nozzle is limited within a planar shape of the workpiece.

6: The thermal processing method according to claim 5, wherein the liquid contains a water substituting agent that improves a water draining property of the workpiece.

7: The thermal processing method according to claim 5, wherein in processing the workpiece, a liquid level of the liquid is controlled to be higher than an upper surface of the workpiece supported by the container, and
in blowing the gas to the workpiece, the liquid level of the liquid is controlled to be lower than the upper surface of the workpiece supported by the container.
